(19) United States
(12) Patent Application Publication
(10) Pub. No.: US 2016/0370952 A1
(43) Pub. Date: Dec. 22, 2016

(54) VISUAL INTERACTIVE VOICE RESPONSE SYSTEM

(71) Applicant: i800, Inc., Fremont, CA (US)

(72) Inventor: Santhosh Karnewar, Fremont, CA (US)

(73) Assignee: i800, Inc., Fremont, CA (US)

(21) Appl. No.: 14/741,200

(22) Filed: Jun. 16, 2015

(51) Int. Cl. G06F 3/0482; G06F 3/0484; H04M 3/493

(52) U.S. Cl. CPC G06F 3/0482; H04M 3/493; G06F 3/04842

(57) ABSTRACT

A method for an interactive voice response system has the steps of customers calling a customer service number using a smart phone,_the app validates incoming calls from customers and provides the registered company's customer service menu to the customer in text form on the customer's display, the Main Menu is displayed and the customer selects from the Main Menu to navigate to a sub menu via page redirection, an application server will look for all open call ports within the dialed company, and if call ports are busy then the mobile application will display the message “Call Waiting” and a queue number for the customer will be displayed along with an average wait time, and once the mobile application finds a free port then the call will be automatically connected and agent name and call related details are displayed.

### BACKGROUND OF THE INVENTION

Typically customers call a customer service number (be it customer service for a Bank or for some product or any customer service number) and have to go through a tiresome automated (IVRS) voice menu in order to get support, which is annoying and time consuming.

Past and existing IVRS systems are touch-tone or voice based, holds customer on voice line till entire voice prompt message gets completed, takes longer, not safe in public places when consumer need to provide his personal info to agents, many times the IVRS does not recognize the spoken language and have to repeat frustratingly. Consumer need to spend or burn his/her voice minutes and at the same time company/industries need to have more telephone lines and call agents to cater to the call volume.

Therefore there is a need for a system that is generic to any company, and requires no additional mobile app. It will reduce number of telephone lines and cheaper for consumer & Company. Such a solution would eliminate the customer's voice minute cost and eliminate or reduce wait time. It would also reduce the number of telephone lines a company leases and also the call agents a company hires to service customers, while providing customers with faster and better customer service support.

### SUMMARY

A method for an interactive voice response system has the steps of customers calling a customer service number using a smart phone, the app validates incoming calls from customers and provides the registered company's customer service menu to the customer in text form on the customer's display, the Main Menu is displayed and the customer selects from the Main Menu to navigate to a sub menu via page redirection, an application server will look for all open call ports within the dialed company, and if call ports are busy then the mobile application will display the message “Call Waiting” and a queue number for the customer will be displayed along with an average wait time, and once the mobile application finds a free port then the call will be automatically connected and agent name and call related details are displayed.

In an embodiment the customer selects a language from the Menu. In an embodiment, during the wait there is no voice session until a Free Call port is available, and customers may multitask on the Smart phone such as surfing the web on browser, play a game, listen to music or run chores. In a further embodiment, upon call termination, the user is redirected to a survey page with call case id/reference number displaying on it to allow customers to track call history details which will stored on the mobile application and the server.

### DESCRIPTION OF THE FIGURES

FIG. 1 shows a flow chart for the Interactive Voice Response System, according to an embodiment of the invention;

FIG. 2 shows a detailed flow chart for the Interactive Voice Response System, according to an embodiment of the invention;

FIG. 3 shows a sequence diagram for the Interactive Voice Response System, according to an embodiment of the invention; and

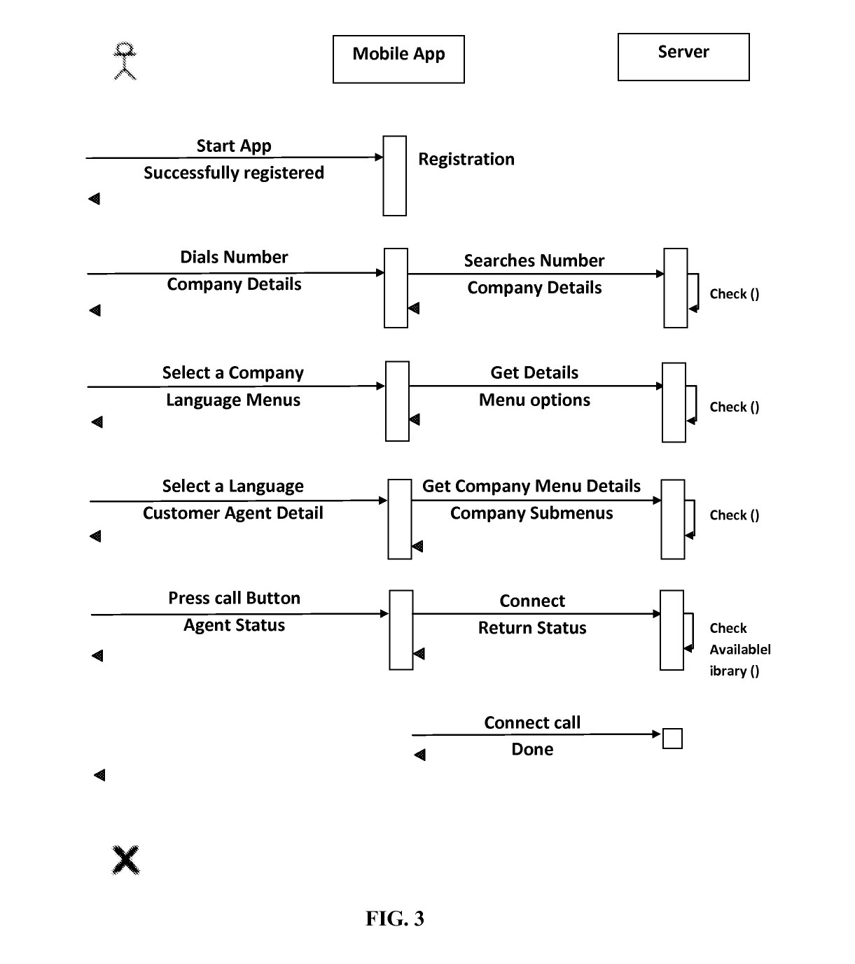

FIG. 4 shows class diagrams for the Interactive Voice Response System, according to an embodiment of the invention.

### DETAILED DESCRIPTION OF THE INVENTION

The present invention reduces the customer's anytime voice minute cost (customers usually have limited “ANYTIME” call minutes), eliminates or reduces the wait time. This will reduce the number of telephone lines a company leases. Provide Customers a faster and better customer service support. This will allow to collects customer information & feedback through visual forms & surveys at the initiation or termination of the call. Also simplifies the mechanism through which customer transmits text or data (via Chat) of interest to the other person (Agent vs Customer) on the other side of the call. Allows customers to exchange text/image or chat messages in real time, while on the phone call with the other party, who is on the side of the call.

Disclosed is a Generic Mobile app (“IVRS”) to dial any customer service number and allows them to choose customer service options of a company via visual menu system and also allows consumer to provide their account details via encrypted text submission. The claimed invention differs from what currently exists. This system is generic to any company. Any industry associated with my software will require no additional mobile app. A single mobile app will serve and dynamically populates such company's customer service options and security parameter requests on consumers our mobile app. Consumer will only need to download one single app for all companies. It will reduce number of telephone lines and cheaper for consumer & Company.

The Version of The Invention Discussed Here Includes:
1. Mobile SMART IVRS System for (iPhone/ANDRIOD/BLACKBERRY/WINDOWS MOBILE)
2. Smart IVRS Web Engine, API Server with Database component

Relationship Between The Components:

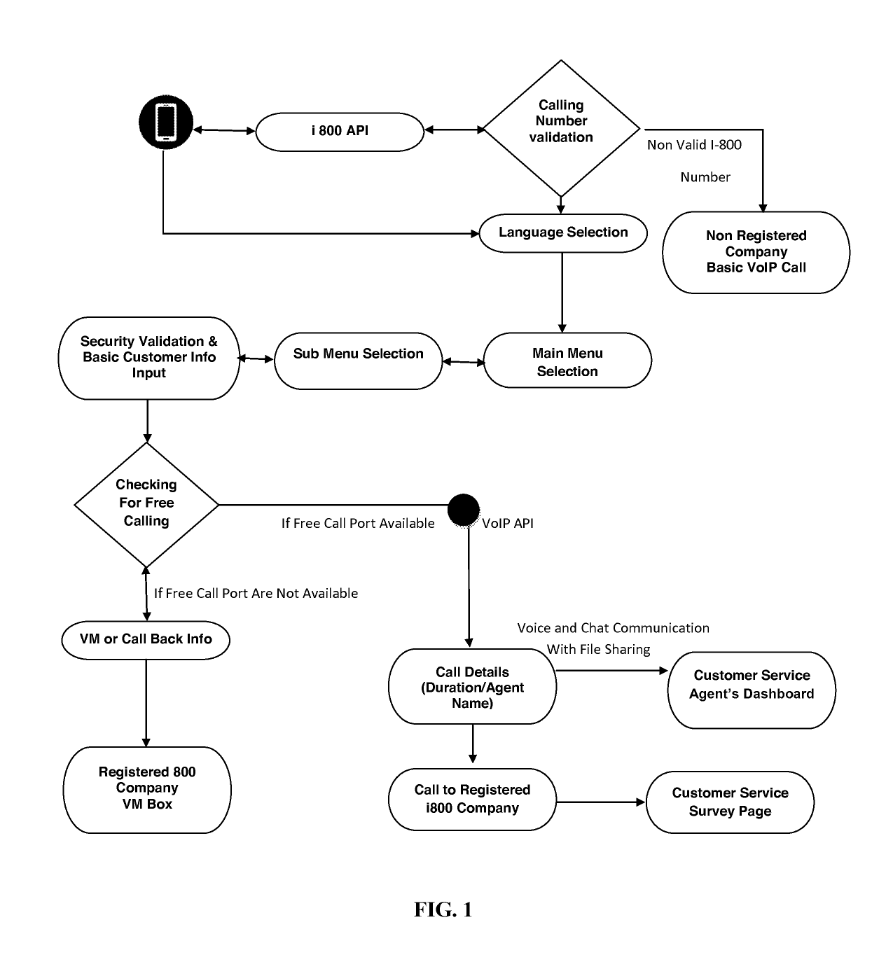

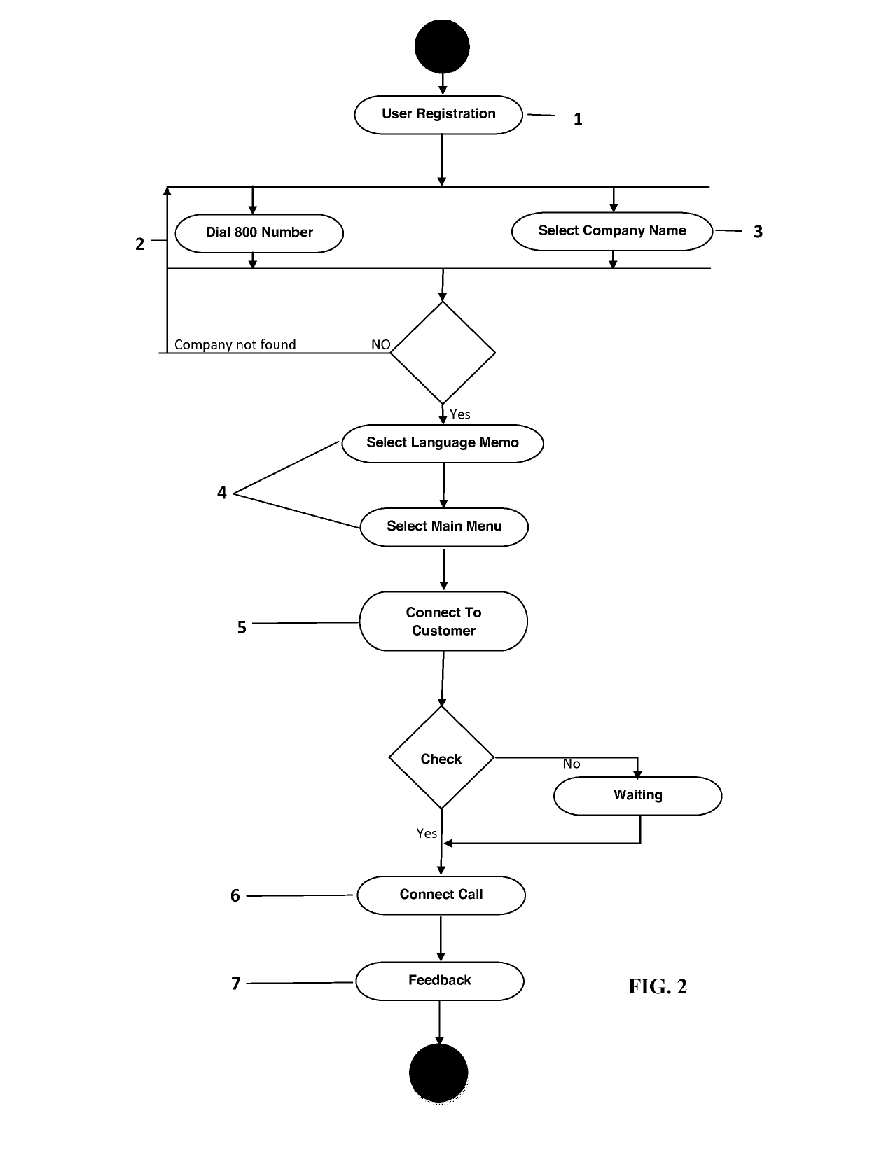

With reference to FIGS. 1 and 2, the following steps are followed:

Step 1. Customers will call the 1-800 numbers or the customer service number using a smart phone. The app is called IVRS, and may be integrated into existing apps of companies, for example a banking app. The user may click on a number that they see on a browser window and it will bring up the IVRS app as a browser app to complete the call.

Step 2. The IVRS app will validate incoming calls from customers and provide the registered company's Customer service menu to the Customer in Text form. For Example the Language option will be provided to the Customer in text format. Currently the customer will hear an automated message in IVRS that says Press 1 for English, 2 for Spanish etc. The customer will have to listen to the automated voice and then make a selection. But if the customer uses the mobile app, then the mobile app will provide the same menu in text form so the customer can just touch the option and will be taken to the next step in the validation process. Selecting the language is only the first step in the validation process. There are many companies that have long menus which take a long time for the customer to listen and go through all the options. If it's displayed as text then the customer does not have to sit and listen through all the messages but can navigate quickly by making a selection (touching the option in the app).

Step 3 (Optional). Once the customer selects the language from the Menu then the Main Menu will be displayed. The Customer can then select from the Main menu to navigate to a sub menu via page redirection (in the case of the mobile application).

Step 4. Once Customer completes this selection the IVRS mobile application Server will look for all open call ports within the dialed company. If call ports are busy then the mobile application will display the message “Call Waiting” and a “Queue Number” will be displayed along with the “Average Wait time”.

Step 5. While the app shows the customer the Average Wait Time the customer can do one of the following
Leave a Voice Message or text message with call back number
End the call or
Continue to hold

Step 6. If the customer chooses to hold then the customer can do his work while the app is waiting for a free port. Once the mobile application finds a free port then the call will be automatically connected and Agent Name or call related details will be displayed.

Step 7. During call with Agent, IVRS allows user to communicate with agent using chat window built in to IVRS call page. The chat feature has the capability of image, video and file transfer.

Step 8. During this entire process there will be no voice session until a Free Call port is available. This will allow customers to multitask on the Smart phone such as surfing the web on browser, play a game, listen to music or run chores.

Step 9. Upon call termination, IVRS user will be redirected to a survey page with call case id/reference number displaying on it, it will allow customers to track call history details which will stored on locally on mobile & IVRS server as well.

How The Invention Works:

As stated earlier there are two major components, 1st component is Mobile App and 2nd one is Web engine with mobile API plugins. Customer service workflow will be designed for each company on Web engine and work flow will be associated with agents desk numbers or softphone (softphone is another feature of this solution), once workflow is published back to Web engine, our mobile app will display published workflow once mobile user dials such customer service number. Customer service number will be validated with Web engines database via our service API. If it is valid number Web Engine will return Menu back to Mobile app and will populate rest of option by validating options/menus chosen by user in mobile app.

At end of work flow user will be prompted with security validation parameters, upon providing such info, our VOIP API will open connection between mobile app and agent's desk number or softphone. IF there is no free port available Web engine will redirect Mobile user to voice message page where user can leave either a text form of message for call center or a voice message. If it is active call, Agent Name will be provided back on Mobile App with call duration and upon termination of the call, the call reference number will be provided back to user on mobile app from web engine and a customer survey page will be populated on mobile app and results will be stored back to Web engine and shared with company.

Check dialed number from mobile app, validate with registered numbers (API will communicate with Web Engine). If dialed number is valid, populate Menu associated with this number. Series of menu selection will be loaded upon prior menu selections, and will prompt user security validation. Check for free agent, if available, connect to Agent else redirect to Voice message page. If user press END button on active call, it will terminate call and return call the reference number with survey option. In Voice Message, User can leave Voice Message or Text Message.

When IVRS app user dials a customer service number, IVRS WEB API will communicate with IVRS App server to check if the dialed number is registered company with IVRS service or not. If it is a registered number then IVRS web application server will return menu items associated with that number back IVRS mobile app. User will select desired menu item from provided menu, depending up on selection of menu item, next item related or associated menu item will be displayed back to IVRS mobile app user. Up reaching to end of menu item work flow, user will be redirected to security validation or information input form, upon submitting information, IVRS web application server will receive information and validate customer information with associated company via encrypted api/web service, if customer is valid IVRS api will return basic information to IVRS mobile app else IVRS will return no information found message and will check for available agent at contact center, if agent is available call will be connected else IVRS mobile app user will be redirected to Call waiting page, if IVRS user selects to stay on hold, call waiting number(queue) and avg. wait time will be provided else he will be redirected to voice message page where user will leave text or voice message.

How To Make The Invention:

For any invention, first identify pain point in current world of order and think out of box solution around it to reduce or eliminate pain point.

Creative, SMART (Specific, Attainable, Measurable, Relevant and Time-bound) and better user adaptability will make invention work better and these are necessary. Simple UI, better information and faster response will make my invention work better. Here I need Smart Mobile Phone app, Web services/Web Technology and VOIP service are important elements for necessary for my invention.

This invention will work better if there is better mobile data signal otherwise there will be some voice quality issues.

How To Use The Invention:

User will dial a customer service number from my mobile app or he/she will search number from our search engine provided in app. Once user dials the number, he/she will be prompted with menus/option of company associated with dialed number. Upon selecting desired options, user will be prompted to fill in his/her security information such as account number, last 4 digits of SSN, upon submission of above information mobile app api will check for available agent, if none available it will redirect to voice message page where user will either leave voice message or text message with call back number and agent will call back customer by sending push notification regarding his call to IVRS user. If Agent is available then there will be voice connection open between user on app and agent using VoIP technology. User can provide necessary information via provided chat to agent during voice call. Agent name and details will be populated back to Mobile app for user with call duration. Once user ends the call, the call reference number will be provided back on app with customer survey page.

Also, this invention includes inbuilt survey mechanism, IVRS mobile users will be redirected to default survey page after each call, which will help companies in collecting feedback more efficiently without depending upon other third party survey tools.

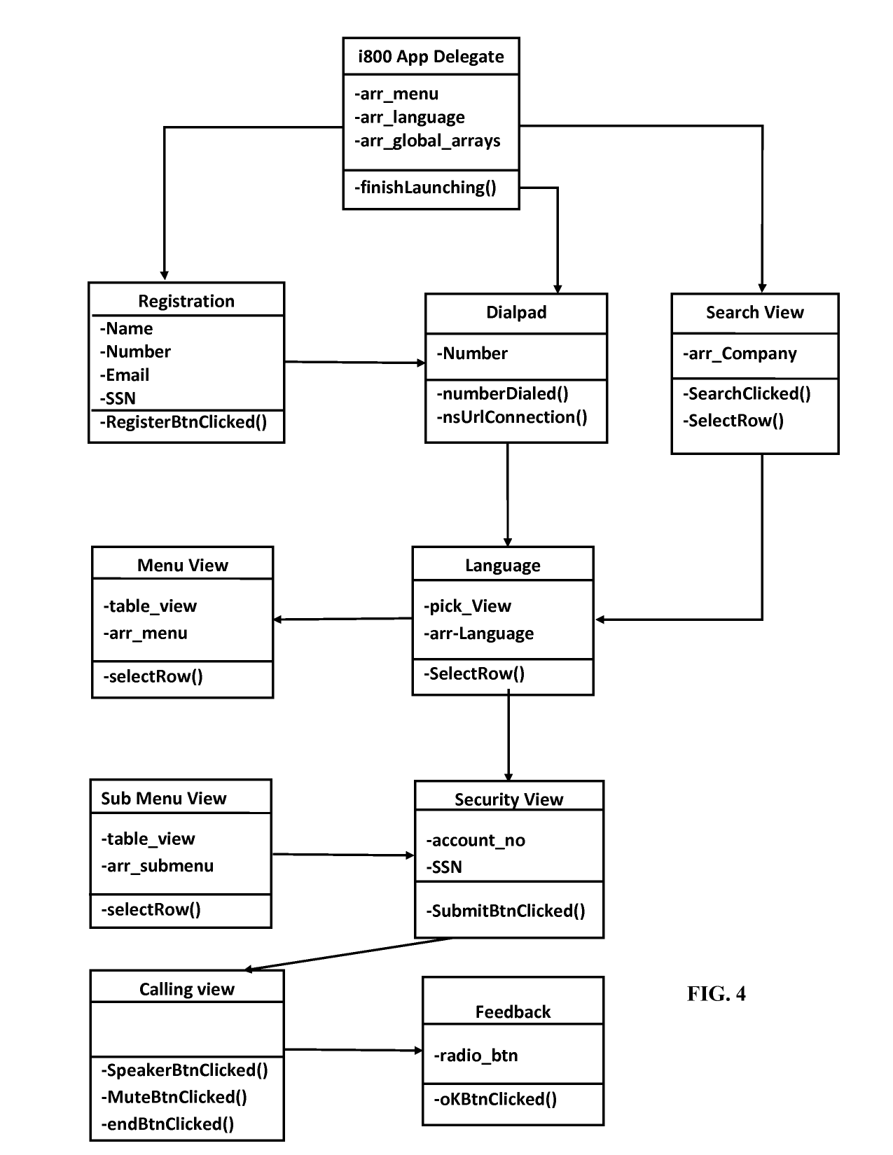

With reference to FIG. 4, an embodiment of a class diagram, various classes are shown by which to implement the invention in using a programming language.

1. A method for an interactive voice response system, comprising the steps of:
a. customers call a customer service number using a smart phone;
b. the app validates incoming calls from customers and provides the registered company's customer service menu to the customer in text form on the customer's display;
c. the Main Menu is displayed and the customer selects from the Main Menu to navigate to a sub menu via page redirection;
d. an application server will look for all open call ports within the dialed company, and if call ports are busy then the mobile application will display the message “Call Waiting” and a queue number for the customer will be displayed along with an average wait time;
e. while waiting the customer may continue to hold, leave a voice message or text message with call back number or end the call;
f. once the mobile application finds a free port then the call will be automatically connected and agent name and call related details are displayed; and
g. the user may communicate with the agent using a chat window built in to the call page.

2. The method of claim 1 wherein the customer selects a language from the Menu.

3. The method of claim 1 wherein during the wait there is no voice session until a Free Call port is available, and customers may multitask on the Smart phone such as surfing the web on browser, play a game, listen to music or run chores.

4. The method of claim 1 wherein upon call termination, the user is redirected to a survey page with call case id/reference number displaying on it to allow customers to track call history details which will stored on the mobile application and the server.
